(19) United States
(12) Patent Application Publication
(10) Pub. No.: US 2026/0031272 A1
(43) Pub. Date: Jan. 29, 2026

(54) CONTROL DEVICE

(71) Applicant: MITSUBA Corporation, Gunma (JP)

(72) Inventors: HIKARU SAWADA, Gunma (JP); YASUFUMI NOGUCHI, Gunma (JP); NOBUHIRO SHIMIZU, Gunma (JP); HIROAKI HIRUMA, Gunma (JP); HIROAKI OKADA, Gunma (JP)

(73) Assignee: MITSUBA Corporation, Gunma (JP)

(21) Appl. No.: 19/263,415

(22) Filed: Jul. 8, 2025

(30) Foreign Application Priority Data
Jul. 23, 2024 (JP) 2024-117807

(51) Int. Cl. H01G 2/10; H01G 2/08

(52) U.S. Cl. CPC H01G 2/106; H01G 2/08

(57) ABSTRACT

Provided is a control device that includes a capacitor, a case, an insulation member, and a thermally conductive adhesive with high thermal conductivity. The case has a capacitor mounting wall with high thermal conductivity and accommodates the capacitor inside with the capacitor mounted on the capacitor mounting wall. The insulation member is interposed between the capacitor mounting wall and a portion of the capacitor. The thermally conductive adhesive is interposed in a region between the capacitor mounting wall and the capacitor where the insulation member is not disposed.

### CROSS-REFERENCE TO RELATED APPLICATION

This application claims the priority benefits of Japanese application no. 2024-117807, filed on Jul. 23, 2024. The entirety of the above-mentioned patent application is hereby incorporated by reference herein and made a part of this specification.

### BACKGROUND

### Technical Field

The disclosure relates to a control device in which a capacitor is accommodated in a case.

### Description of Related Art

As a control device for motor driving, there is known one that converts DC power supplied from a battery to AC power and drives a motor with the converted AC power. This type of control device accommodates, in a case, a substrate on which electronic components are mounted and a capacitor for smoothing current. As the capacitor used here, an aluminum electrolytic capacitor or the like is used, but that type of capacitor easily generates heat due to ripple current that occurs. For this reason, it is desirable to efficiently dissipate heat in order to prevent deterioration of the capacitor due to heat.

For this reason, in this type of control device, the capacitor mounting wall of the case may be formed of a metal with high heat dissipation properties (e.g., aluminum), and the capacitor may be mounted on the capacitor mounting wall.

However, although coating is applied to the outer surface of the capacitor, the insulation by coating is often insufficient. For this reason, as a countermeasure, a method has been devised in which an insulation member is interposed between the capacitor mounting wall and the capacitor (e.g., see Patent Document 1, International Publication No. 2018/128005).

The technology described in Patent Document 1 has insulation paper disposed on the upper surface of a metal capacitor mounting wall, and a capacitor is mounted on the insulation paper. The capacitor is resin molded in the case in this state. In the case of this technology, heat from the capacitor is dissipated to the outside through the insulation paper and the metal capacitor mounting wall, and the capacitor and the capacitor mounting wall are electrically insulated by the insulation paper.

However, in the technology described in Patent Document 1 above, since insulation paper is disposed over the entire area of the part of the capacitor mounting wall where the capacitor is mounted, heat transmitted from the capacitor to the metal capacitor mounting wall is easily greatly impeded by the insulation paper. For this reason, further improvement in heat dissipation of the capacitor through the capacitor mounting wall is desired.

Further, in the technology described in Patent Document 1 above, the capacitor and insulation paper are fixed on the capacitor mounting wall by molding resin filled in the case. For this reason, the operation for fixing the capacitor to the capacitor mounting wall becomes large-scale, and further improvement is desired in terms of production efficiency.

Thus, the disclosure provides a control device that may improve heat dissipation of a capacitor and enhance efficiency of fixing operation of the capacitor to a capacitor mounting wall.

### SUMMARY

A control device according to one aspect of the disclosure adopts the following configuration.

That is, a control device according to one aspect of the disclosure includes: a capacitor, a case, having a capacitor mounting wall with high thermal conductivity and accommodating the capacitor inside with the capacitor mounted on the capacitor mounting wall, an insulation member, interposed between the capacitor mounting wall and a portion of the capacitor, and a thermally conductive adhesive with high thermal conductivity, interposed in a region between the capacitor mounting wall and the capacitor where the insulation member is not disposed.

With the above configuration, the capacitor and the capacitor mounting wall are electrically insulated by the insulation member. The capacitor is fixed on the capacitor mounting wall by the thermally conductive adhesive disposed in a region between the capacitor mounting wall and the capacitor where the insulation member is not disposed. In fixing the capacitor, if the thermally conductive adhesive is applied to parts on the capacitor mounting wall where the insulation member is not disposed, the fixing operation of the capacitor may be completed by simply placing the capacitor on the insulation member and waiting for the adhesive to cure. Further, the thickness of the thermally conductive adhesive interposed between the capacitor and the capacitor mounting wall may be made substantially constant by the insulation member. Further, heat emitted by the capacitor during use of the control device is transmitted to the capacitor mounting wall through the thermally conductive adhesive with high thermal conductivity. As a result, heat from the capacitor is favorably dissipated to the outside.

A plurality of insulation members may be disposed to support a plurality of spaced locations in an extending direction of the capacitor.

In this case, since the capacitor is supported by a plurality of insulation members disposed at spaced intervals, the capacitor may be maintained in a stable posture until the thermally conductive adhesive cures. Further, with this configuration, it becomes easier to maintain a constant gap between the capacitor and the capacitor mounting wall where the thermally conductive adhesive is interposed. Thus, in the case of adopting this configuration, it becomes possible to more easily perform the fixing operation of the capacitor with the thermally conductive adhesive, and it becomes easier to make the thickness of the thermally conductive adhesive uniform.

The capacitor may be a cylindrical capacitor, a plurality of capacitors may be arranged in parallel in a direction intersecting with an axial direction of the capacitors, the insulation members may be disposed at a position spanning one end side in an axial direction of each of the plurality of capacitors and at a position spanning other end side in an axial direction of each of the plurality of capacitors, and the thermally conductive adhesive may be disposed between the capacitor mounting wall and each of the capacitors in a region between the insulation member disposed at a position spanning the one end side and the insulation member disposed at a position spanning the other end side.

In this case, one end side and the other end side in the axial direction of the plurality of capacitors are respectively supported by one corresponding insulation member. Thus, it becomes possible to stably support the plurality of capacitors by two insulation members at the front and rear in the axial direction in an electrically insulated state. Further, the plurality of capacitors arranged in parallel are stably adhesively fixed to the capacitor mounting wall by the thermally conductive adhesive in the region between the two insulation members.

The insulation member may be an insulation paper.

In this case, it becomes possible to electrically insulate the capacitor from the capacitor mounting wall by insulation paper that is easy to handle. Further, since insulation paper has a thin thickness, it becomes possible to bring the capacitor closer to the capacitor mounting wall and further enhance the heat dissipation of the capacitor.

The insulation member disposed at a position spanning the one end side and the insulation member disposed at a position spanning the other end side may be formed in a trapezoidal congruent shape, and positioning portions may be disposed at positions on the capacitor mounting wall where two of the insulation members are mounted, and the positioning portions are configured to engage with corner portions of each of the insulation members.

In this case, by engaging each corner portion of the two insulation members with the positioning portions on the capacitor mounting wall, it becomes possible to install the two insulation members at respective specified positions on the capacitor mounting wall. Further, since the two insulation members have a trapezoidal congruent shape, insulation members of common specifications may be utilized at two locations.

### BRIEF DESCRIPTION OF THE DRAWINGS

FIG. 1 is a perspective view of the control device of the embodiment.

FIG. 2 is an exploded perspective view of the control device of the embodiment.

FIG. 3 is a perspective view of the control device of the embodiment with some components removed.

FIG. 4 is a plan view of the control device of the embodiment with some components removed.

FIG. 5 is a cross-sectional view of the control device of the embodiment taken along line V-V of FIG. 4.

### DESCRIPTION OF THE EMBODIMENTS

The above-described control device ensures insulation of the capacitor by the insulation member disposed between the capacitor and the capacitor mounting wall, and may obtain fixing of the capacitor to the capacitor mounting wall and good heat transfer performance by the thermally conductive adhesive interposed between the capacitor and the capacitor mounting wall. Thus, according to the above-described control device, it is possible to plan improvement of heat dissipation of the capacitor and efficiency enhancement of the fixing operation of the capacitor to the capacitor mounting wall.

Hereinafter, one embodiment of the disclosure is described with reference to the drawings.

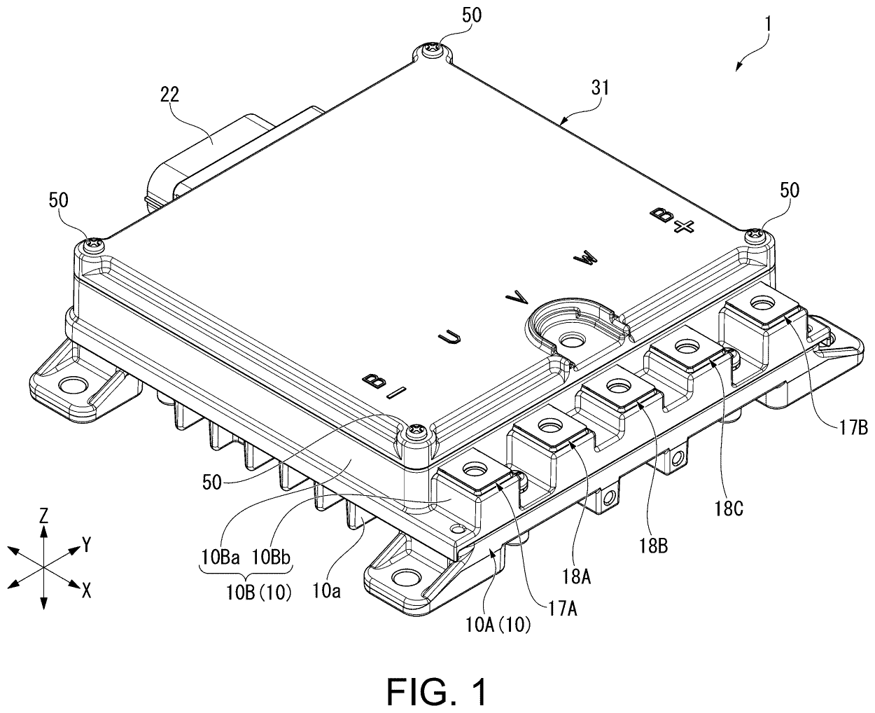

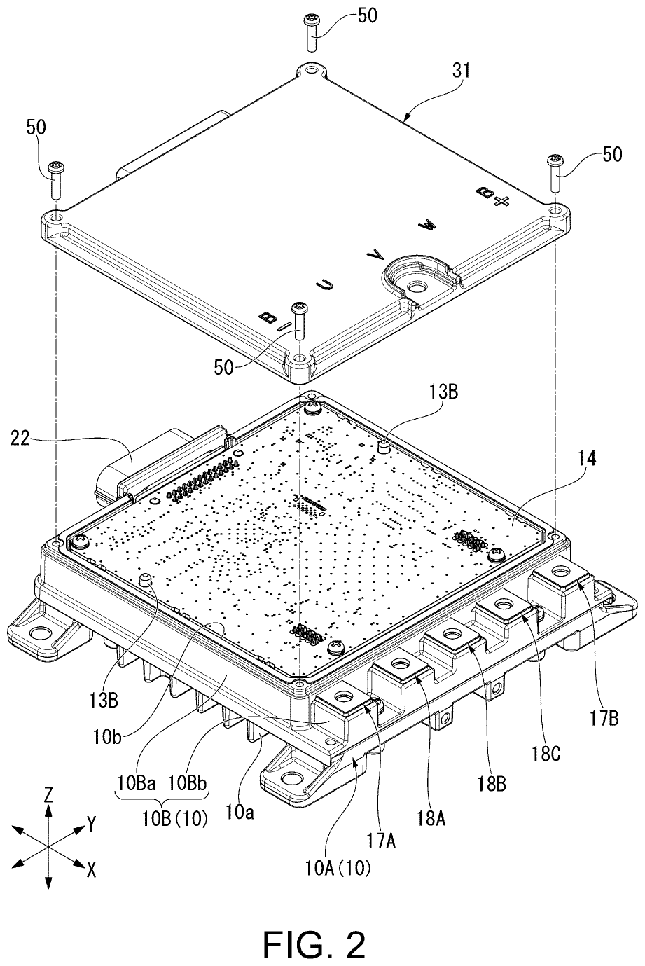

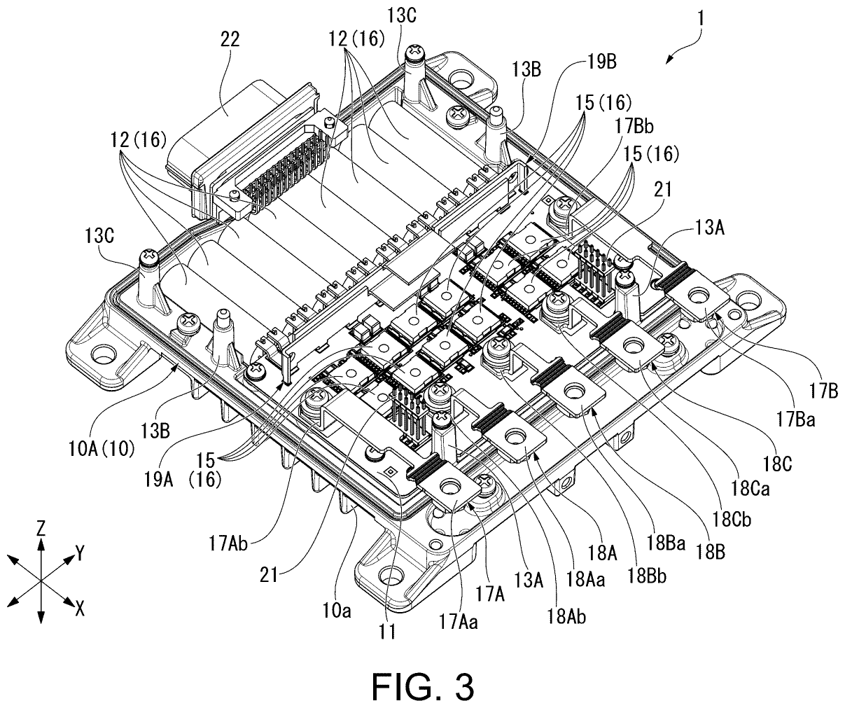

FIG. 1 is a perspective view of the control device 1, and FIG. 2 is an exploded perspective view of the control device 1 of this embodiment. Further, FIG. 3 is a perspective view of the control device 1 with some components removed.

The control device 1 includes an inverter function that converts DC power supplied from a battery (not shown) to AC power and drives a motor (AC motor, not shown) with the converted AC power. As shown in FIG. 2, the control device 1 includes a thin rectangular parallelepiped case 10 with one surface having an opening. A plurality of fins 10a for heat dissipation protrude from the outer surface of the case 10. The opening 10b of the case 10 is closed by a cover 31 as shown in FIG. 1. The cover 31 is detachably attached to the case 10 by a plurality of screws 50. Hereinafter, for convenience of description, the side of the case 10 having the opening 10b is referred to as “upper,” and the opposite side is referred to as “lower.

### <Overall Configuration of Control Device>

The case 10 includes a base member 10A made of aluminum alloy (metal) formed by aluminum die casting or the like, and a case main body 10B made of resin fixed to the upper portion of the base member 10A. The base member 10A is formed in a substantially rectangular shape in top view. On the upper surface side of the base member 10A, a first substrate 11 and a plurality of capacitors 12, etc. (see FIG. 3) to be described in detail later are attached. On the lower surface side of the base member 10A, a plurality of fins 10a for heat dissipation are formed.

The case main body 10B includes a main body block portion 10Ba having a rectangular frame shape in top view, and a busbar support portion 10Bb connected to one side surface of the main body block portion 10Ba. The main body block portion 10Ba has the above-mentioned opening 10b that opens upward. The periphery of the first substrate 11 and the plurality of capacitors 12 attached to the upper surface side of the base member 10A is surrounded by the peripheral wall of the main body block portion 10Ba. The busbar support portion 10Bb supports one end portion of each of a plurality of busbars (battery side busbars 17A and 17B and motor side busbars 18A, 18B, and 18C).

FIG. 3 shows a state in which the case main body 10B and the cover 31 are removed together with a second substrate 14 to be described later.

As shown in FIG. 3, a plurality of pillar portions 13A, 13B, and 13C that project toward the upper side are provided on the upper surface of the base member 10A. A second substrate 14 is supported on the upper portions of the plurality of pillar portions 13A, 13B, and 13C as shown in FIG. 2. The second substrate 14 is disposed above the first substrate 11 and the plurality of capacitors 12, substantially parallel to the first substrate 11. As shown in FIG. 3, the first substrate 11 is disposed toward one side of the upper surface of the base member 10A having a substantially rectangular shape in top view, and the plurality of capacitors 12 are disposed toward the other side of the upper surface of the base member 10A.

The first substrate 11 is a printed wiring board (PWB) on which a plurality of electronic components, including switching elements 15, are mounted. A plurality of switching elements 15 are combined to constitute a main portion of a power control circuit 16 together with the capacitor 12. The power control circuit 16 performs ON/OFF operations through the control of the switching elements 15 by a controller (not shown), thereby converting the direct current power from the battery into three-phase alternating current power.

The power control circuit 16 is connected to a pair of battery side busbars 17A and 17B, which serve as electrodes for conducting electricity on the battery side, and three motor side busbars 18A, 18B, and 18C, which serve as electrodes for conducting electricity on the motor side. The pair of battery side busbars 17A and 17B are connectable to the positive and negative terminals of the battery, respectively, through connection cables (not shown). The three motor side busbars 18A, 18B, and 18C are connectable to the U-phase, V-phase, and W-phase power supply portions of the motor, respectively, through connection cables (not shown).

As shown in FIG. 3, the capacitors 12 disposed toward the other side of the base member 10A are formed in a substantially cylindrical shape. These plurality of capacitors 12 are arranged in parallel in a direction perpendicular to the longitudinal direction (axial direction). The plurality of capacitors 12 are connected to circuits on the first substrate 11 via connection busbars 19A and 19B that are surface-mounted on the first substrate 11. The capacitor 12 is constituted by, for example, an aluminum electrolytic capacitor or the like. The specific structure of the mounting portion of the capacitor 12 on the base member 10A will be described in detail later.

Hereinafter, the direction along the longitudinal direction (axial direction) of the capacitor 12 is referred to as the X direction. Further, the direction in which the capacitors 12 are arranged in parallel is referred to as the Y direction, and the direction perpendicular to the X direction and Y direction is referred to as the Z direction. Arrows indicating the X direction, Y direction, and Z direction are marked at appropriate locations in the drawings.

On the upper surface of the first substrate 11, positive side circuit terminals and negative side circuit terminals (not shown), which serve as power input portions from the battery, are mounted. These circuit terminals are configured near the end portions on two sides of the first substrate 11 in the Y direction. The battery side busbars 17A and 17B, which serve as electrodes for conducting electricity, are connected to the positive side circuit terminals and the negative side circuit terminals on the first substrate 11, respectively.

The battery side busbars 17A and 17B are both formed by long plate-shaped conductive metal plates. For each battery side busbar 17A and 17B, one end side in the longitudinal direction is formed as a terminal fixing portion 17Aa and 17Ba to be attached to the upper surface of the case 10 on one end side in the X direction, and the other end side in the longitudinal direction is formed as a circuit fixing portion 17Ab and 17Bb to be connected to the aforementioned positive side circuit terminal and negative side circuit terminal on the first substrate 11. The battery side busbars 17A and 17B are fixed to the busbar support portion 10Bb and the first substrate 11 at the terminal fixing portions 17Aa and 17Ba and the circuit fixing portions 17Ab and 17Bb, respectively, such that the longitudinal direction is along the X direction. Further, portions of each battery side busbar 17A and 17B penetrate the peripheral wall of the main body block portion 10Ba and are embedded in the peripheral wall.

Further, on the upper surface of the first substrate 11, three output side circuit terminals (not shown) for U-phase, V-phase, and W-phase, which serve as power output portions to the motor, are mounted. These output side circuit terminals are disposed in the central region in the Y direction of the first substrate 11, spaced substantially equally in the Y direction. The motor side busbars 18A, 18B, and 18C, which serve as electrodes for conducting electricity, are connected to each of these output side circuit terminals, respectively.

The motor side busbars 18A, 18B, and 18C are formed by long plate-shaped conductive metal plates, similar to the battery side busbars 17A and 17B. For each motor side busbar 18A, 18B, and 18C, one end side in the longitudinal direction is formed as a terminal fixing portion 18Aa, 18Ba, and 18Ca to be attached to the upper surface of the case 10 on one end side in the X direction, and the other end side in the longitudinal direction is formed as a circuit fixing portion 18Ab, 18Bb, and 18Cb to be connected to each of the aforementioned output side circuit terminals on the first substrate 11. Each motor side busbar 18A, 18B, and 18C is fixed to the busbar support portion 10Bb and the first substrate 11 at the terminal fixing portions 18Aa, 18Ba, and 18Ca and the circuit fixing portions 18Ab, 18Bb, and 18Cb, respectively, such that the longitudinal direction is along the X direction. Portions of each motor side busbar 18A, 18B, and 18C penetrate the peripheral wall of the main body block portion 10Ba and are embedded in the peripheral wall, similar to the terminal fixing portions 17Aa and 17Ba.

The second substrate 14 is a printed wiring board (PWB) on which electronic components are mounted. The circuit printed on the second substrate 14 is connected to the circuit on the first substrate 11 via a board-to-board connector 21 (see FIG. 3). Further, a signal connector 22 is connected to the other end in the X direction of the second substrate 14. The signal connector 22 is sandwiched from above and below by the case main body 10B and the cover 31, and is fixed to the case main body 10B and the cover 31 in that state. A plurality of signal terminals protruding from the signal connector 22 are also connected to the circuit on the second substrate 14.

### <Mounting Portion of Capacitor>

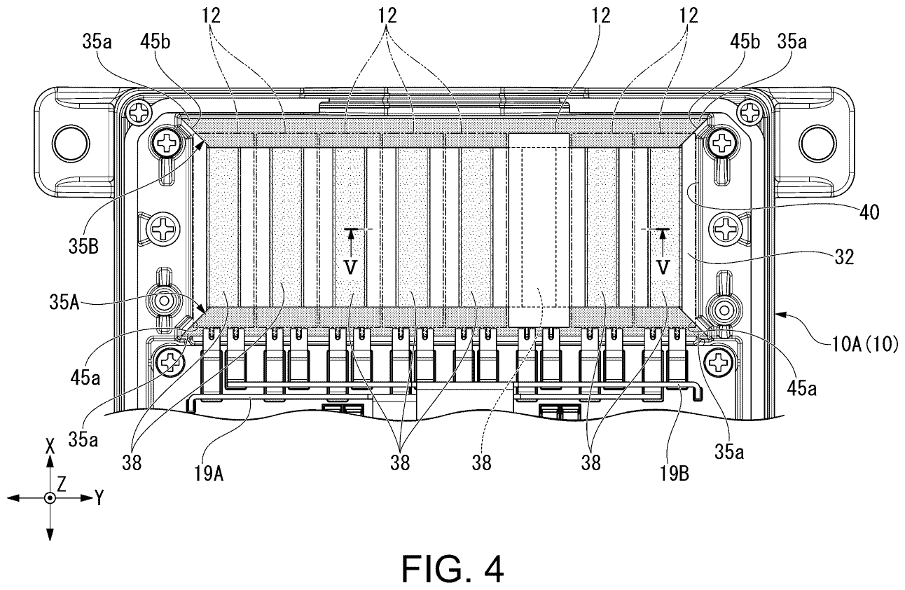

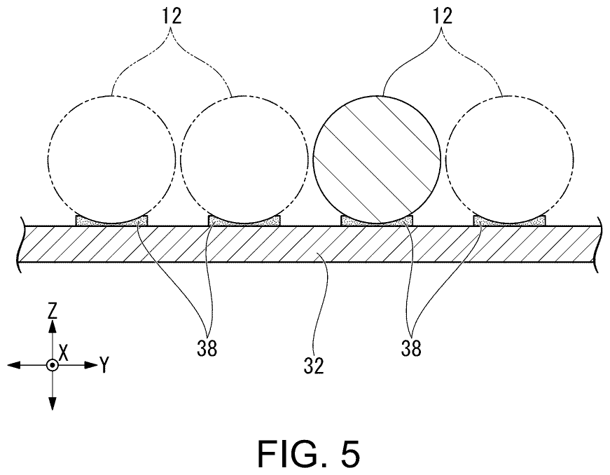

FIG. 4 is a plan view of the control device 1 with some components removed. FIG. 4 shows a state in which the case main body 10B and the cover 31 are removed together with the second substrate 14, similar to FIG. 3. Further, in FIG. 4, some of the plurality of capacitors 12 installed on the base member 10A are shown by virtual lines. FIG. 5 is a cross-sectional view along line V-V of FIG. 4.

As shown in FIG. 4, an accommodation recessed portion 40 is formed in the other end side region in the X direction of the upper surface of the base member 10A to accommodate and arrange a plurality of capacitors 12. The accommodation recessed portion 40 is formed in a substantially rectangular shape in top view. The short side of the accommodation recessed portion 40 extends along the X direction, and the long side of the accommodation recessed portion 40 extends along the Y direction. A plurality of capacitors 12 are accommodated in the accommodation recessed portion 40 such that the axial direction of the capacitors 12 is along the X direction (short side of the accommodation recessed portion 40).

At the left and right (left and right in FIG. 4) corner portions of one end side and the other end side in the X direction of the accommodation recessed portion 40, recess portions 45a and 45b having a substantially right triangular shape in top view that extend outward in the left and right direction beyond the short sides of the accommodation recessed portion 40 are continuously provided. The left and right recess portions 45a on one end side in the X direction are formed such that one side of the substantially triangular shape is continuous with the long side of one end side in the X direction of the accommodation recessed portion 40. Similarly, the left and right recess portions 45b at the other end in the X direction are formed such that one side of the substantially triangular shape is continuous with the long side of the other end side in the X direction of the accommodation recessed portion 40. That is, the recess portions 45a and 45b at the four corners are formed to extend each corner portion of the accommodation recessed portion 40 in the left and right direction (Y direction).

It is noted that in the accommodation recessed portion 40, a plurality of capacitors 12 are arranged side by side in parallel in the Y direction.

In this embodiment, the bottom walls of the accommodation recessed portion 40 and the recess portions 45b and 45a at the four corners constitute the capacitor mounting wall 32. The capacitor mounting wall 32 is formed of a metal material with high thermal conductivity, similar to other parts of the base member 10A.

On the capacitor mounting wall 32, two strip-shaped insulation papers 35A and 35B are attached with spacing in the X direction. The two insulation papers 35A and 35B are formed in congruent shapes that are trapezoidal in top view. Each insulation paper 35A and 35B includes acute-angled corner portions 35a at the end portions in the length direction. One insulation paper 35A is mounted on the capacitor mounting wall 32 such that its long side follows along the side of one end side in the X direction of the accommodation recessed portion 40. At this time, the left and right corner portions 35a of the insulation paper 35A are engaged with the corresponding left and right recess portions 45a. Further, the other insulation paper 35B is mounted on the capacitor mounting wall 32 such that its long side follows along the side of the other end side in the X direction of the accommodation recessed portion 40. At this time, the left and right corner portions 35a of the insulation paper 35B are engaged with the corresponding left and right recess portions 45b.

It is noted that in this embodiment, the insulation papers 35A and 35B constitute the insulation member.

The two insulation papers 35A and 35B are positioned on the capacitor mounting wall 32 by the corner portions 35a being engaged with the corresponding recess portions 45a and 45b. In this embodiment, the recess portions 45a and 45b constitute the positioning portion where the corner portions of the insulation member (insulation papers 35A and 35B) are engaged.

The two insulation papers 35A and 35B attached on the capacitor mounting wall 32 are spaced apart by a predetermined distance in the X direction. In this state, the plurality of capacitors 12 are mounted on the two insulation papers 35A and 35B. At this time, the plurality of capacitors 12 are mounted such that one end side in the respective axial direction is mounted on the upper surface of one insulation paper 35A, and the other end side in the respective axial direction is mounted on the upper surface of the other insulation paper 35B.

This means that from the perspective of the insulation papers 35A and 35B (insulation member), the insulation papers 35A and 35B are arranged at positions that span one end side in the respective axial direction of the plurality of capacitors 12 and at positions that span the other end side in the respective axial direction of the plurality of capacitors 12.

It is noted that as a preliminary stage before the plurality of capacitors 12 are mounted on the upper surfaces of the two insulation papers 35A and 35B as described above, thermally conductive adhesive 38 with high thermal conductivity is applied to the region where insulation paper does not exist between the two insulation papers 35A and 35B on the capacitor mounting wall 32.

As shown in FIG. 4, the thermally conductive adhesive 38 is applied along the X direction directly below the position where each capacitor 12 is arranged on the capacitor mounting wall 32. The thermally conductive adhesive 38 is applied with a constant width on the capacitor mounting wall 32, and in response to each capacitor 12 being mounted on the two insulation papers 35A and 35B, the central region in the width direction is crushed by the outer peripheral surface of each capacitor 12 (see FIG. 5). At this time, the thickness of the thermally conductive adhesive 38 in the part crushed by the outer peripheral surface of the capacitor 12 becomes the same thickness as the thickness of the insulation papers 35A and 35B.

After each capacitor 12 is mounted on the two insulation papers 35A and 35B in this manner, in response to the thermally conductive adhesive 38 curing, each capacitor 12 is fixed on the capacitor mounting wall 32 by the thermally conductive adhesive 38.

It is noted that it is preferable to use a UV curing type for the thermally conductive adhesive 38. In the case of using a UV curing type as the thermally conductive adhesive 38, it becomes possible to rapidly fix the capacitor 12 on the capacitor mounting wall 32 without applying heat to the capacitor 12 by irradiating ultraviolet rays to the adhesive application portion.

### (Operation and Effect)

As described above, in the control device 1 of this embodiment, the insulation papers 35A and 35B (insulation member) are interposed between the capacitor mounting wall 32 of the case 10 and a portion of the capacitor 12, and the thermally conductive adhesive 38 is interposed in the region where the insulation papers 35A and 35B are not arranged between the capacitor mounting wall 32 and the capacitor 12. Thus, the capacitor 12 and the capacitor mounting wall 32 are electrically insulated by the insulation papers 35A and 35B, and the capacitor 12 is fixed on the capacitor mounting wall 32 in the region without the insulation papers 35A and 35B.

In the case of fixing the capacitor 12 on the capacitor mounting wall 32, by applying the thermally conductive adhesive 38 to the region where the insulation papers 35A and 35B are not arranged and mounting the capacitor 12 on the insulation papers 35A and 35B in that state, the fixing operation of the capacitor 12 may be completed by only waiting for the curing of the thermally conductive adhesive 38. Thus, the fixing operation of the capacitor 12 to the capacitor mounting wall 32 may be performed efficiently.

Further, in the control device 1 of this embodiment, heat emitted by the capacitor 12 may be efficiently transmitted to the capacitor mounting wall 32 through the thermally conductive adhesive 38. Further, the thickness of the thermally conductive adhesive 38 interposed between the capacitor 12 and the capacitor mounting wall 32 may be managed to be substantially constant by the thickness of the insulation papers 35A and 35B.

Thus, in the case of adopting the control device 1 of this embodiment, it is possible to plan improvement of heat dissipation of the capacitor 12 and efficiency enhancement of the fixing operation of the capacitor 12 to the capacitor mounting wall 32. Consequently, this may contribute to the United Nations' Sustainable Development Goals (SDGs), specifically Goal 7 “Ensure access to affordable, reliable, sustainable and modern energy for all” and Goal 8 “Promote sustained, inclusive and sustainable economic growth, full and productive employment and decent work for all”.

Further, in the control device 1 of this embodiment, a plurality of insulation members (insulation papers 35A and 35B) are arranged to support a plurality of spaced locations in the extending direction of the capacitor 12. Thus, the capacitor 12 may be maintained in a stable posture until waiting for the curing of the thermally conductive adhesive 38. Further, in the case of this configuration, it becomes easier to maintain the gap between the capacitor 12 and the capacitor mounting wall 32 where the thermally conductive adhesive 38 is interposed more constantly. Thus, in the case of adopting the control device 1 of this embodiment, it becomes possible to perform the fixing operation of the capacitor 12 by the thermally conductive adhesive 38 more easily, and it becomes possible to make the thickness of the thermally conductive adhesive 38 uniform and efficiently dissipate heat from the outer surface of the capacitor 12 to the outside. It is noted that in this embodiment, two locations spaced in the axial direction of the capacitor 12 are supported on the capacitor mounting wall 32 by two insulation papers 35A and 35B (insulation members), but the capacitor 12 may be supported by insulation members at three or more locations spaced in the extending direction.

Further, in the control device 1 of this embodiment, a plurality of cylindrical capacitors 12 are arranged in parallel in a direction intersecting with the axial direction of the capacitors 12, and two insulation papers 35A and 35B (insulation members) are arranged at positions spanning one end side in the axial direction of each of the plurality of capacitors 12 and at positions spanning the other end side in the axial direction of each of the plurality of capacitors 12. Then, the thermally conductive adhesive 38 is arranged between the capacitor mounting wall 32 and each capacitor 12 in a region between one insulation paper 35A (insulation member) and the other insulation paper 35B (insulation member). Thereby, one end side and the other end side in the axial direction of the plurality of capacitors 12 are supported by the corresponding insulation papers 35A and 35B, respectively. Thus, in a state where the central region in the axial direction of the plurality of capacitors 12 is electrically insulated by the thermally conductive adhesive 38, two end portions in the axial direction of the plurality of capacitors 12 may be stably supported by the two insulation papers 35A and 35B.

Furthermore, the control device 1 of this embodiment may stably bond and fix the plurality of capacitors 12 arranged in parallel to the capacitor mounting wall 32 by the thermally conductive adhesive 38 in the region between the two insulation papers 35A and 35B.

Further, the control device 1 of this embodiment adopts insulation papers 35A and 35B as insulation members. Thus, the capacitor 12 may be electrically insulated from the capacitor mounting wall 32 by the insulation papers 35A and 35B that are easy to handle. Further, in the case of this configuration, since the thickness of the insulation papers 35A and 35B that are insulation members is thin, the capacitor 12 may be brought closer to the capacitor mounting wall 32, and the heat dissipation of the capacitor 12 may be further enhanced.

Furthermore, in the control device 1 of this embodiment, the two insulation papers 35A and 35B are formed in trapezoidal congruent shapes, and at the positions on the capacitor mounting wall 32 where the two insulation papers 35A and 35B are placed, recess portions 45a and 45b (positioning portions) are formed into which the corner portions 35a of each insulation paper 35A and 35B engage. Thus, by engaging each corner portion 35a of the two insulation papers 35A and 35B with the recess portions 45a and 45b on the capacitor mounting wall 32, the two insulation papers 35A and 35B may be accurately installed at respective specified positions on the capacitor mounting wall 32.

Further, in this configuration, since the two insulation papers 35A and 35B have trapezoidal congruent shapes, the insulation papers 35A and 35B of common specifications may be used at two corresponding locations on the capacitor mounting wall 32. This makes it possible to reduce the number of parts used.

It should be noted that the disclosure is not limited to the above-mentioned embodiment, and various design changes are possible within the scope of the disclosure. For example, in the above embodiment, an aluminum electrolytic capacitor is adopted as the capacitor 12, but the type of capacitor is not limited thereto. Various other types of capacitors may be used.

Further, in the above embodiment, insulation papers 35A and 35B are adopted as insulation members, but the insulation members are not limited to insulation papers. The insulation members may be, for example, insulating resin or ceramic. Even in the case of insulation members being members other than insulation papers 35A and 35B, it is desirable that they be sheet-like members with constant and thin thickness.

Further, in the above embodiment, the entire area of the base member 10A including the capacitor mounting wall 32 is formed of a metal material with high thermal conductivity. However, the configuration of the base member is not limited thereto, and only a portion of the base member including the capacitor mounting wall 32 may be formed of a metal material.

What is claimed is:

1. A control device, comprising:
a capacitor;
a case, having a capacitor mounting wall with high thermal conductivity and accommodating the capacitor inside with the capacitor mounted on the capacitor mounting wall;
an insulation member, interposed between the capacitor mounting wall and a portion of the capacitor; and
a thermally conductive adhesive with high thermal conductivity, interposed in a region between the capacitor mounting wall and the capacitor where the insulation member is not disposed.

2. The control device according to claim 1, wherein a plurality of insulation members are disposed to support a plurality of spaced locations in an extending direction of the capacitor.

3. The control device according to claim 2, wherein the capacitor is a cylindrical capacitor,
a plurality of capacitors are arranged in parallel in a direction intersecting with an axial direction of the capacitors,
the insulation members are disposed at a position spanning one end side in an axial direction of each of the plurality of capacitors and at a position spanning other end side in an axial direction of each of the plurality of capacitors, and
the thermally conductive adhesive is disposed between the capacitor mounting wall and each of the capacitors in a region between the insulation member disposed at a position spanning the one end side and the insulation member disposed at a position spanning the other end side.

4. The control device according to claim 3, wherein the insulation member is an insulation paper.

5. The control device according to claim 3, wherein the insulation member disposed at a position spanning the one end side and the insulation member disposed at a position spanning the other end side are formed in a trapezoidal congruent shape, and
positioning portions are disposed at positions on the capacitor mounting wall where two of the insulation members are mounted, and the positioning portions are configured to engage with corner portions of each of the insulation members.

6. The control device according to claim 4, wherein the insulation member disposed at a position spanning the one end side and the insulation member disposed at a position spanning the other end side are formed in a trapezoidal congruent shape, and
positioning portions are disposed at positions on the capacitor mounting wall where two of the insulation members are mounted, and the positioning portions are configured to engage with corner portions of each of the insulation members.
